(19) United States
(12) Patent Application Publication
(10) Pub. No.: US 2018/0249312 A1
(43) Pub. Date: Aug. 30, 2018

(54) Mobile Device as a Form of Identification via Bluetooth

(71) Applicants: Byung Mun Roh, New York, NY (US); Wazir Rafeek, Newburgh, NY (US)

(72) Inventors: Byung Mun Roh, New York, NY (US); Wazir Rafeek, Newburgh, NY (US)

(21) Appl. No.: 15/928,662

(22) Filed: Mar. 22, 2018

(51) Int. Cl. H04W 4/80; H04W 12/06

(52) U.S. Cl. CPC H04W 4/80; H04L 67/306; H04W 12/06

(57) ABSTRACT

A method for the utilization of one's mobile device as a means of identification that uses a device's Bluetooth capabilities to transmit encrypted data and authenticate an individual's identity. An application interface on the user's mobile device allows for the display of a digital identification card containing an individual's necessary identifying and authenticating data. This digital identification card is intended to replace the need for physical identification cards with magnetic strips or NFC capabilities and allow for building access, point of sale transactions or simple visual identification, among other potential uses. The wireless authentication process is initiated by opening the application interface on a mobile device with that device's Bluetooth capabilities enabled, and waving the device in the vicinity of a second, Bluetooth enabled, authenticating device. The second device, upon querying a database used to store the necessary identification data, provides authentication and confirmation as to the device user's identity.

### CROSS-REFERENCE TO RELATED APPLICATIONS

Not applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable.

### STATEMENT REGARDING PRIOR DISCLOSURES BY THE INVENTOR OR A JOINT INVENTOR

Not Applicable.

### BACKGROUND OF THE INVENTION

The present invention relates to a method to be used for the purpose of relaying identifying information between one's mobile device, a database or databases hosted on a server or servers, and another device to be used as the recipient of that information for the purpose of authenticating one's identity. More particularly, it relates to a method for the use of a mobile device application that would take advantage of a given mobile device's Bluetooth capabilities in order to securely communicate with, a scanning or information receiving device, when in the vicinity of the scanning or receiving device.

Mobile device use is now pervasive and as the capabilities of such devices continue to grow at an exceptional rate, one's smartphone has quickly become an indispensable tool and accessory, as have other mobile devices such as smartwatches, “wearables,” tablets and the like. Among the core capabilities of a mobile device is the storing and transmission of data to other similarly capable devices. As such, the need for an individual to carry a typical identification card with the long used magnetic strip on the back, or even a radio-frequency identification card (RFID), no longer exists as mobile devices are now capable of storing and securely transmitting any, information such that the mobile device in question might be used in the place of a traditional identification card. Furthermore, the creation of an ID system that utilizes mobile devices allows for information to be sent as well as received, unlike traditional ID cards and systems that only allow for the sending of information once a card is swiped (but not the receipt of information in response). Bluetooth in particular, presents itself as the ideal mechanism by which an identification authentication process can and should take place with a mobile device.

The flexibility of Bluetooth technology makes it a worthwhile means of wirelessly transmitting information. With Bluetooth, the ability to be used in either an active or passive mode allows for the occurrence of an identification event or experience, even when a mobile device is locked or not in use; perhaps while in an individual's pocket. Additionally, Bluetooth devices could potentially be used to build indoor positioning systems (IPS), as part of the Internet of Things (IoT), or as a beacon. In a different context, mobile devices have been proposed and patented for making purchases by displaying barcodes to be read by point-of-sale readers. In such cases, and in other similar contexts where a mobile device may be used for identifying purposes, near-field communication (NFC), rather than Bluetooth technology is utilized. This is the case with the invention found in U.S. Pat. No. 8,731,583 B2 which represents an interactive identification system using mobile devices, but one that makes specific use of NFC. Unlike Bluetooth, NFC lacks some flexibility in that the connection time between devices communicating via NFC cannot be controlled by an administrator. Likewise, whereas NFC connections are simply a quick “handshake” between two devices, Bluetooth connections do not have a time limit and thus can potentially include additional authentication steps during a given connection rather than prior to that connection. Furthermore, the requirement of close proximity related to NFC use is not one that is shared by Bluetooth as the range of the latter technology is much greater than the former. That the connection via Bluetooth can be encrypted, the length of time and speed of the connection can be managed and the distance within which devices connect can be controlled all allow embodiments of the present invention to preemptively allay any potential security concerns associated with the aforementioned advantages of Bluetooth, particularly the vastly improved connectivity range.

There remains a need in the art for a system and method that would allow for the use of one's mobile device in the manner in which an identification card has customarily been utilized, and to do so specifically by transmitting necessary identifying information and details via Bluetooth.

### BRIEF SUMMARY OF THE INVENTION

Taking into account the shortcomings of prior art, the present invention is a method for the utilization of a mobile device for the purpose of identification via Bluetooth connectivity and with the use of a mobile device application. As such, the invention enables individuals to forgo carrying a physical identification card and utilize that which has now become indispensable to most, their cellular phone or some other mobile device, as their sole means of identifying themselves.

In the preferred embodiment, the present invention involves the storing of an individual's identification data on an organizational identification system as moderated, customized and maintained by a system administrator. As such, an individual with a Bluetooth enabled mobile device will approach a second Bluetooth enabled device the purpose of which will be to scan nearby devices in order to authenticate identity, and once the first device is in the vicinity of this second device in order to commence an “identifying event.” Such an identifying event represents the point at which an individual would attempt to authenticate one's identity to gain access to a “service,” such as entry into a building for example. The two aforementioned devices communicate via Bluetooth so that, as part of a two-step authentication process, device one transmits data to device two which allows for the authentication of the mobile device user's identity, at which point device two then communicates with the aforementioned organizational system to determine whether access to a requested service is granted or denied dependent upon the user's identity. Furthermore, the scanning device will consistently scan for broadcasts from nearby individual user mobile devices and only allow access to a service in the event of an identity match after processing and parsing a number of specific and limited variables previously input by the system administrator. The use of these variables allows the system administrator to dictate who may access a service, what service may be accessed, when it may be accessed, and the range of distance that the broadcasting mobile device must be within for access to be granted. An application interface on the individual's mobile device may be utilized display the user's basic identifying data, or other information as dictated by the system administrator depending upon the context in which the present invention is intended to be utilized.

Accordingly, it is an object of the present invention to enable the verification and authentication of data that might be found on a physical identification card, via Bluetooth, such that one's mobile device can be used in the place of a customary identification card to identify oneself generally, to enter buildings, or to denote attendance at an event or place, among other uses.

It is another object of the present invention to provide a more secure identification system than is currently widely utilized, particularly in regards to plastic identification cards with NFC or RFID or even mobile device identification via NFC. The use of Bluetooth and thus an active, bidirectional connection, allows for electronic detection of tampering and fraud for more security improving functionality than is possible with an ordinary physical identification card.

It is yet another object of the present invention to allow for a more customizable and simultaneously more precise means of determining an individual's identity overseen by a system administrator with the ability to not only predetermine the database of specific and unique identities that will be able to gain access to specific services, but also the specific times during which such access may be granted and any other potentially necessary limiting variables that would allow the system administrator to further customize the invention for their needs and uses.

These and many other objects and advantages will be readily apparent to one skilled in the art to which the invention pertains from a perusal of the claims and the following detailed description of preferred embodiments.

### BRIEF DESCRIPTION OF THE SEVERAL VIEWS OF THE DRAWING(S)

Not Applicable.

### DETAILED DESCRIPTION OF THE INVENTION

A preferred embodiment of the invention is now described in detail. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention provides a method for the novel use of a mobile device's Bluetooth capabilities. The invention, more specifically described as a method for the use of a mobile device as a means of identification via Bluetooth, particularly Bluetooth Low Energy, is a very specific method to efficiently and securely allow for the use of Bluetooth communication between devices for the purpose of taking attendance, entering buildings, accessing events, engaging in point of sale transactions or allowing for other uses of a mobile device in instances where identity authentication is required and where a magnetic or RFID enabled physical identification card may have been used in the past and to this point.

The invention calls for the use of two distinct devices, both Bluetooth enabled; one of these two devices is utilized to scan for Bluetooth broadcasts (the “central”), while the other device will be an individual user's personal mobile device (the “peripheral”). With a system administrator using Universally Unique Identifiers (“UUID”) to distinguish between different types of services and characteristics that the invention will moderate as part of what will be a two-step identification process, the central is set beforehand to scan nearby transmitting peripherals for a limited set of identification values, specifically the Bluetooth Generic Attributes (GATT), prior to providing access to the service in question once the second step of the identification and authorization process is completed and the user's identification and profile data is verified and confirmed. As part of this aforementioned two-step process, the invention first calls for the broadcast of Bluetooth Low Energy signals by the peripheral, with the central connecting to the peripheral in the event the two devices are within a previously prescribed connection range and the UUIDs are a match. Upon connecting, the central verifies that the device user is the genuine owner of the identification data and the device in question. The second step of authentication requires the central to verify that the individual using the device is capable and approved to receive the service being requested by making use of the transmitted identification data. The service, such as unlocking a door or allowing for a point of sale transaction for example, is only granted once both of these authentications have taken place. As indicated, another variable to be limited, predetermined and input by the system administrator is the range of Received Signal Strength Indicator (“RSSI”) values which serves as a proxy for the physical range between the two Bluetooth devices, within which the central will accept a broadcast from a peripheral in the event that there is a UUID match, and thus provide the requested service in the event the individual is capable of receiving such service based upon their identification data. The database of all potential user identification and profile data shall be stored separately on a distinct server (or servers and such se s) shall be utilized to communicate with the central for authentication purposes with regard to providing a service.

An application interface designed for user input and interaction on the peripheral allows for the individual mobile device user to see specific information as predetermined by the system administrator, but also to potentially interact with the central to the extent that may be necessary to initiate the invention's processes and functionalities. While this application interface is open on a user's mobile device, whether in the background or foreground, the device will emit a Bluetooth signal for the purpose of being recognized by the scanning device (the central). When the peripheral is within the aforementioned predefined range (as indicated by the RSSI) and its advertising data contains the UUID that the central is looking for, the central initiates the connection with the peripheral. Outside of said range, broadcasts from peripherals will not be accepted by the central. Once a connection has been made, the central then verifies the mobile device user's identity and receives the necessary identification data upon authentication. To further detail the first step of the invention's two-step authentication system, the recognition, by the central, of ‘advertising data’ (which includes the “GATT service”) broadcast via Bluetooth from a peripheral that is within acceptable range, then results in the central communicating with the designated database(s) and server(s) of user identification and profile data in order to parse the database for a matching value associated with a particular UUID. Finding and evaluating such a match results in the authentication of the mobile device and thus the device user's ability to receive a given service.

The primary distinguishing characteristics of the present invention is its use of Bluetooth connectivity and functionality in order to initiate an interaction between devices and transmit information. Doing so allows for additional flexibility in terms of Bluetooth's innate capabilities in terms of the range at which it can be used, and the high speeds at which large amounts of data can be transmitted. The present invention and this particular embodiment specifically make use of Bluetooth's flexibility, particularly over NFC and other technologies, to ensure heightened security. To that end, the use of decoy data, encryption of data and the signing of transmitted data to ensure that such data is coming from a valid source further ensure the security aspects of the present invention. Bluetooth's two-way communication ability also allows for more power in maintaining security unlike other technologies that only allow for communication in one direction, or from one device to another, but not back to the original device.

While a preferred embodiment of the present invention has been described, it is understood that the embodiment described is illustrative only and that the scope of the invention is to be defined solely by the appended claims when accorded a full range of equivalence, many variations and modifications naturally occurring to those skilled in the art from the perusal thereof.

What is claimed is:

1. A method for the utilization of a mobile device as a means of identification via such device's Bluetooth capabilities comprising:
a first Bluetooth enabled mobile device in communication with a second, authenticating, Bluetooth enabled device;
a customizable system made up of servers and databases;
a mobile application interface to be accessed on the first Bluetooth enabled mobile device;
an information exchange and authentication protocol between said mobile devices conducted wirelessly, via Bluetooth;
which allows for a request from device two in order to allow or deny an individual access to a given service;

2. The method for the utilization of a mobile device as a form of identification as defined in claim 1 wherein the system is comprised of a server or servers containing databases that store individual user profiles.

3. The method for the utilization of a mobile device as a form of identification as defined in claim 1 wherein Universally Unique Identifiers (“UUID”) are utilized to assign necessary individual attributes and identifying characteristics dependent upon the service being requested.

4. The method for the utilization of a mobile device as a form of identification as defined in claim 1 wherein the second Bluetooth enabled device is set by a system administrator as the “central” and the first Bluetooth device operates as and is referred to as the “peripheral.”

5. The method for the utilization of a mobile device as a form of identification as defined in claim 4 wherein said peripheral is an individual user's personal mobile device and the central is used as a scanning device.

6. The method for the utilization of a mobile device as a form of identification as defined in claim 5 wherein said central controls the connection and communication between itself and peripherals.

7. The method for the utilization of a mobile device as a form of identification as defined in claim 4 wherein said centrals constantly scan for a UUID as defined in claim 3.

8. The method for the utilization of a mobile device as a form of identification as defined in claim 1 wherein said application interface provides the means of user input by which an identity authentication request takes place.

9. The method for the utilization of a mobile device as a form of identification as defined in claim 5 wherein the peripheral begins broadcasting Bluetooth signals that contain the UUID, as defined in claim 3, once the mobile application interface is opened by the device user and continues broadcasting so long as said mobile application interface remains running whether in the foreground or the background of the mobile device.

10. The method for the utilization of a mobile device as a form of identification as defined in claim 9 wherein a user's identity as the genuine, sole owner of the peripheral is first identified before identification data is shared via the Bluetooth broadcast.

11. The method for the utilization of a mobile device as a form of identification as defined in claim 9 wherein the central, as defined in claim 5, detects the UUID via the Bluetooth broadcast from the peripheral in order to verify it as a match for one of the UUIDs it has been set to scan for by the system administrator, when the central and peripheral are within range.

12. The method for the utilization of a mobile device as a form of identification as defined in claim 5 wherein a system administrator is able to set a specific distance beyond which the central does not process broadcasts from peripherals.

13. The method for the utilization of a mobile device as a form of identification as defined in claim 12 wherein the central utilizes the received signal strength indicator to verify the distance between it and the peripheral only in instances where the UUID detected is a match for what it has been set to scan for.

14. The method for the utilization of a mobile device as a form of identification as defined in claim 13 wherein the central, when a broadcasting peripheral is within the necessary distance prescribed by the system administrator, makes a read request for a specific service.

15. The method for the utilization of a mobile device as a form of identification as defined in claim 14 wherein the central, based upon the identification data received from the peripheral, makes a request to the system for a specific service or services in the event the peripheral user's identity has been initially authenticated.

16. The method for the utilization of a mobile device as a form of identification as defined in claim 15 wherein the request for a service is granted or denied dependent upon the identification data initially shared by the peripheral, whether or not that identification data is a match for data contained within the system, and the evaluation of that data proves eligibility for the service.

17. The method for the utilization of a mobile device as a form of identification as defined in claim 14 wherein the peripheral sends the requested read value back to the central in order to provide the requested service.
